(19) United States
(12) Patent Application Publication
(10) Pub. No.: US 2011/0042121 A1
(43) Pub. Date: Feb. 24, 2011

(54) ELECTRICAL CABLE PROTECTION BLOCK

(76) Inventors: Bernard I. Rogers, Kenner, LA (US); William W. Toth, Newark, OH (US)

Correspondence Address: Calfee, Halter & Grlswold LLP, 800 Superior Ave E, Suite 1400, Cleveland, OH, 44114, US

(21) Appl. No.: 12/545,191

(22) Filed: Aug. 21, 2009

(51) Int. Cl. H01B 7/00

(52) U.S. Cl. 174/135

(57) ABSTRACT

An electrical cable protection block includes a body having an inner wall, an outer walls a lumen within the inner and outer walls and a connection structure. The connection structure is provided to secure a first electrical cable protection block to a second electrical cable protection block. Typically the connection structure comprises cooperating male and female ends. The male end may take the form of a collar while the female end may take the form of a bore sized and shaped to receive that collar.

### TECHNICAL FIELD AND INDUSTRIAL APPLICABILITY OF THE INVENTION

This invention relates to an electrical cable protection block particularly adapted for protecting electrical cables from exposure to high temperature molten materials that may inadvertently leak or spill from molten material handling and processing equipment.

### BACKGROUND OF THE INVENTION

There has long been a need for protecting electrical cables and control lines in the area of industrial equipment particularly adapted for handling and processing high temperature molten materials such as molten glass. Temperatures of such materials may reach or exceed 2200° to 2600° F. Without appropriate protection the electrical cables and/or control lines may be easily damaged by these high temperature molten materials in the event of an inadvertent leak or spill.

The present invention relates to an electrical cable protection block of relatively simple and inexpensive construction which very effectively protects electrical cables and control lines from damage due to high temperatures in the event of high temperature molten material leaks or spills.

### SUMMARY OF THE INVENTION

In accordance with the purposes of the present invention as described herein, a novel protection block is provided for electrical cables or control lines. The electrical cable protection block comprises a body including an inner wall, an outer wall, a lumen within the inner and outer walls and a connection structure to secure a first electrical cable protection block to a second electrical cable protection block.

More specifically describing the invention, the inner wall of the protection block may be made from a polymer material. That polymer material may be selected from a group of materials consisting of polyvinyl chloride, polytetrafluoroethylene, polyvinylidene fluoride, and mixtures thereof. Further, the polymer material may include reinforcing fiber. That reinforcing fiber may be selected from a group consisting of mineral fiber, glass fiber, basalt fiber, carbon fiber, graphite fiber, and mixtures thereof.

The outer wall is preferably made from a refractory material. That refractory material may be selected from a group consisting of mullite, clay, silica, alumina and mixtures thereof.

In one particularly useful embodiment the connection structure comprises mating male and female ends. The male end may comprise a plug while the female end comprises a socket sized and shaped to cooperatively receive that plug.

In accordance with an additional aspect of the present invention a method is provided for producing an electrical cable protection block. The production method comprises the steps of casting a refractory material between first and second tubes when the first tube is concentrically disposed within the second tube, allowing the refractory material to set and then removing the second tube. In accordance with this method the first tube of polymer material becomes a pail of or is incorporated into the final product.

In accordance with yet another aspect of the present invention a method is provided of protecting electrical cables in areas adjacent high temperature molten material processing equipment. The method comprises the steps of enclosing the electrical cables within a protection block including a wall constructed from a refractory material. The protection block includes a connection structure to secure a first electrical cable protection block to a second electrical cable protection block.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive,

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a cross sectional view of the protection block of the present invention;

FIG. 2 is a cross sectional view similar to FIG. 1 but showing two connection blocks of the present invention connected together; and

FIG. 3 is a cross sectional view showing how the connection block of the present invention is made.

Reference will now be made in detail to the present preferred embodiment of the invention, examples of which are illustrated in the accompanying drawings.

### DETAILED DESCRIPTION OF THE PREFERRED EMBODIMENTS OF THE INVENTION

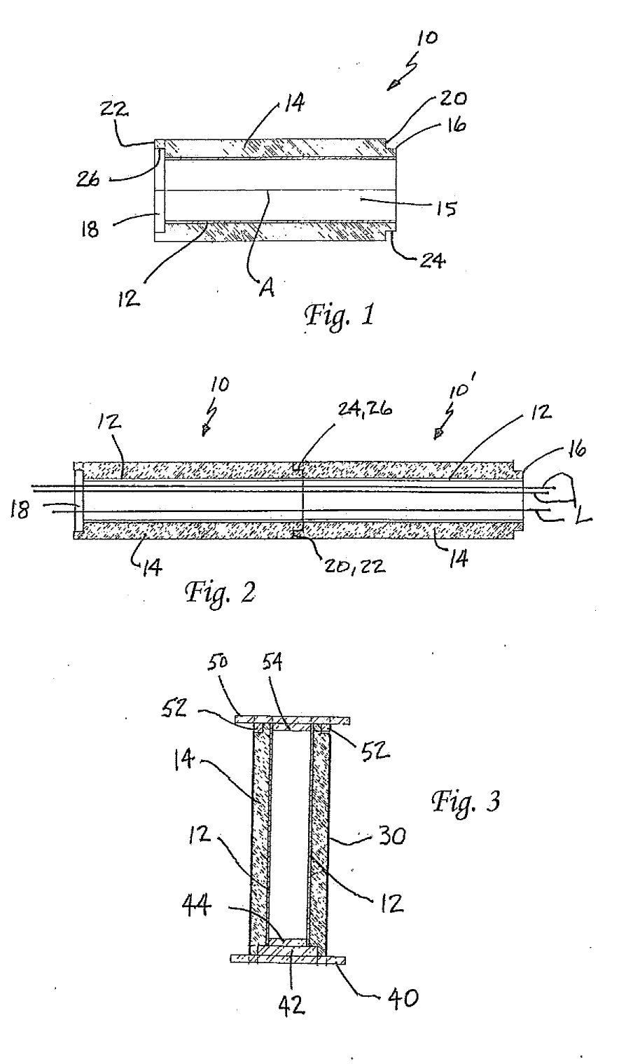

Reference is now made to FIG. 1 illustrating the protection block of the present invention. The protection block 10 is particularly suited for protecting electrical cables and control lines from high temperature molten materials such as molten glass being processed in a fiberglass production plant utilizing molten material handling and processing equipment. As illustrated, the protection block 10 comprises a body including an inner wall 12 and an outer wall 14. A lumen 15 extends through the body within the inner and outer walls 12, 14.

A connection structure is provided to secure a first electrical cable protection block 10 to a second electrical protection block 10′ in an end to end manner as illustrated in FIG. 2. As best illustrated in FIG. 1, each protection block 10, 10′ incorporates a male end comprising a projecting collar 16 and a cooperating female end comprising a bore 18 specifically shaped and sized to receive the collar 16. Thus, the male end with the collar 16 includes two cooperating shoulders. The first shoulder 20 extends substantially perpendicular to the longitudinal axis A of the protection block 10 while the second shoulder 24 extends substantially parallel to that axis. As further illustrated, the bore 18 includes a third shoulder 22 that extends substantially perpendicular to the longitudinal axis A and a second shoulder 26 that extends substantially parallel to that axis.

As best illustrated in FIG. 2, when two protection blocks 10, 10′ are connected in series, the projecting collar 16 of the male end of the first protection block 10 is received snugly within the bore 18 of the second protection block 10′ so that the shoulder 20 abuts the shoulder 22 while the shoulder 24 abuts the shoulder 26.

An air set mullite mortar such as KORUNDAL™ bond, manufactured by Harbison-Walker Refractories Company, may be provided at the interface between the shoulders 20, 22 and/or 24, 26 in order to fully seal and increase the integrity of the connection between the two blocks 10, 10′. Alternatively, mechanical fasteners may be used to complete a secure connection.

As further illustrated in FIG. 2, electrical cables or control lines L extend through the continuous lumen 15 provided by the interconnected protection blocks 10, 10′. Such electrical cables or control lines L are surrounded by the protection blocks 10, 10′ and protected from high temperature molten material spills.

The inner wall 12 of each connection block 10 may be made from a polymer material. That polymer material may be selected from a group of materials consisting of polyvinyl chloride, polytetrafluoroethylene, polyvinylidene flouride and mixtures thereof Further, if desired, that polymer material may include reinforcing fiber materials. Typically the reinforcing fiber material is selected from a group consisting of mineral fiber, glass fiber, basalt fiber, carbon fiber, graphite fiber and mixtures thereof. The inner surface of the inner wall 12 is preferably smooth so as to allow electrical cable and control lines L to be easily extended or pushed through the lumen 15 as desired,

In contrast to the inner wall 12, the outer wall 14 is constructed from a refractory material. That refractory material may be selected from a group of materials consisting of mullite, clay, silica, alumina and mixtures thereof. Mullite is a clay mineral alumino-silicate that has been found to be particularly useful as an outer wall material in the present invention.

The refractory material selected for the outer wall 14 provides excellent high temperature protection for the electrical cable and/or control lines L extending through the lumen 15 of the protection block. In fact, the protection block is capable of protecting electrical cable and control lines L from damage when the protection block 10 is exposed to high temperature molten materials that can reach temperatures up to and including as high as 2600°. Accordingly, the present invention also includes a method of protecting electrical cables in areas adjacent high temperature molten material processing equipment. That method comprises enclosing the electrical cables within a protection block 10 including a wall 14 constructed from a refractory material where that protection block also includes a connection structure 16, 18 to secure a first electrical cable protection block 10 to a second electrical cable protection block 10′ as illustrated in FIG. 2.

The protection block 10 of the present invention may be produced by casting a mixture of water and a refractory material, such as mullite. As illustrated in FIG. 3, the mixture is cast between a first tube of polymer material, which may be inner wall 12, concentrically disposed within a second tube 30 constructed, for example, from treated paperboard. More specifically, first ends of the tubes 12, 30 are positioned on a first end cap 40 including a relief structure 42 adapted to form the bore 18 and a relief structure 44 adapted to support and hold the inner wall 12.

Next, the space between the inner wall 12 and second tube 30 is filled with the mixture containing refractory material. A second end cap 50 is then positioned to seal the second end of the tubes 12, 30. The second end cap 50 includes a relief structure 52 sized and shaped to form the collar 16 and a relief structure 54 adapted to support the inner wall 12.

After the refractory material sets to form the outer wall 14, the end caps 40, 50 are removed. In addition the second tube 30 is removed to complete the production process. In one particularly useful embodiment, the inner wall 12 is constructed from polyvinylchloride and the outer wall 14 is constructed from TAYCOR® 414-FH HYDROCAST, a high alumina castable material available from AHN Refractories, The inner wall 12 has a thickness of about 1.27 centimeters, the outer wall 14 has an outer diameter of about 25.4 centimeters and a thickness of about 4.45 centimeters and the lumen 15 has a diameter of about 15.24 centimeters. Further, the collar 16 has an outer diameter of about 20.64 centimeters and the bore 18 has an inner diameter of about 20.96 centimeters.

The foregoing description of the preferred embodiments of the present invention have been presented for purposes of illustration and description. It is not intended to be exhaustive or to limit the invention to the precise form disclosed. Obvious modifications or variations are possible in light of the above teachings. For example, while the electrical cable protection block 10 illustrated in the drawing figures is circular in cross section, it should be appreciated that other cross sectional shapes may be provided including, but not limited to, oval, square, rectangular or other polygonal shape.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. An electrical cable protection block, comprising:
a body including an inner wall, an outer wall, a lumen within said inner and outer walls and a connection structure to secure a first electrical cable protection block to a second electrical cable protection block.

2. The protection block of claim 1, wherein said inner wall is made from a polymer material.

3. The protection block of claim 2, wherein said polymer material is selected from a group of materials consisting of polyvinyl chloride, polytetrafluoroethylene, polyvinylidene fluoride and mixtures thereof.

4. The protection bock of claim 3, wherein said polymer material includes reinforcing fiber.

5. The protection block of claim 4, wherein said reinforcing fiber is selected from a group consisting of mineral fiber, glass fiber, basalt fiber, carbon fiber, graphite fiber and mixtures thereof.

6. The protection block of claim 5, wherein said outer wall is made from a refractory material.

7. The protection block of claim 6, wherein said refractory material is selected from a group consisting of mullite, clay, silica, alumina and mixtures thereof.

8. The protection block of claim 7, wherein said connection structure comprises mating male and female ends.

9. The protection block of claim 8, wherein said male end comprises a plug and said female end comprises a socket.

10. The protection block of claim 1, wherein said outer wall is made from a refractory material.

11. The protection block of claim 10, wherein said refractory material is selected from a group consisting of mullite, clay, silica, alumina and mixtures thereof

12. A method of producing an electrical cable protection block, comprising:
casting a refractory material between a first tube and a second tube where said first tube is concentrically disposed within said second tube;
allowing said refractory material to set; and
removing said second tube.

13. The method of claim 12, including positioning first ends of said first and second tubes on a first end cap prior to casting said refractory material and positioning a second end cap on second ends of said first and second tubes after casting said refractory material.

14. The method of claim 13, including forming a bore in said refractory material at said first ends of said first and second tubes and forming a collar in said refractory material at said second ends of said first and second tubes.

15. A method of protecting electrical cables in areas adjacent high temperature molten material processing equipment, comprising:
enclosing said electrical cables within a protection block including a wall constructed from a refractory material, said protection block including a connection structure to secure a first electrical cable protection block to a second electrical cable protection block.

16. The method of claim 15 including connecting multiple protection blocks together by mating a male end of a first protection block with a female end of a second protection block.
